(19) United States
(12) Patent Application Publication
(10) Pub. No.: US 2014/0130517 A1
(43) Pub. Date: May 15, 2014

(54) COOLING AND HEATING CUP HOLDER

(71) Applicants: HYUNDAI MOTOR COMPANY, Seoul (KR); KIA MOTORS CORPORATION, Seoul (KR); KBAUTOTECH CO., LTD., Chungcheongnam-do (KR)

(72) Inventors: Man Ju Oh, Gyeonggi-do (KR); Jae Woong Kim, Gyeonggi-do (KR); Jae Woo Park, Gyeonggi-do (KR); Tae Soo Sung, Asan-si (KR)

(73) Assignees: Hyundai Motor Company, Seoul (KR); KBAUTOTECH Co., Ltd., Chungcheongnam-do (KR); Kia Motors Corporation, Seoul (KR)

(21) Appl. No.: 13/844,627

(22) Filed: Mar. 15, 2013

(30) Foreign Application Priority Data
Nov. 12, 2012 (KR) 2012-0127638

(51) Int. Cl. B60N 3/10

(52) U.S. Cl. CPC B60N 3/104
USPC 62/3.3

(57) ABSTRACT

A cup holder, which cools and heats a cup, includes an inner holder, an outer holder, a thermoelectric device and a blower. The inner holder, made of metal, holds the cup therein and has a protrusion on a side portion thereof. An open portion of the protrusion defines a flow hole. The outer holder surrounds a side surface of the inner holder at a predetermined interval, such that a circulation space is formed between the outer holder and the inner holder. The thermoelectric device, disposed in the circulation space, includes first and second sections. The first section closely adjoins the protrusion of the inner holder. The second section extends through the outer holder and is exposed outward. The blower is disposed inside the circulation space adjacent to the flow hole, and enables air inside the inner holder and air inside the circulation space to circulate and transfer heat.

### CROSS-REFERENCE TO RELATED APPLICATION

This application is based on and claims benefit of priority to Korean Patent Application No. 10-2012-0127638, filed on Nov. 12, 2012 in the Korean Intellectual Property Office, the entire contents of which are hereby incorporated by reference.

### TECHNICAL FIELD

The present inventive concept relates to a cooling and heating cup holder which is provided in a vehicle or the like in order to hold a cup therein and cool and heat the cup.

### BACKGROUND

A cup holder is provided in a vehicle or the like. Although such a cup holder generally has a simple holding function, a holder having a cooling and heating function is introduced in some types of vehicles.

The cup holder of the related art generally serves to cool and heat the content therein by simply using thermal conduction. However, the problem is that the cooling and heating function is not sufficiently carried out by simply using thermal conduction.

FIG. 1 shows a cooling and heating cup holder of the related art. Although the cooling and heating cup holder of the related art uses a Peltier device 20, heat is transferred to and from a cup holder body 10 only via conduction in order to enable the function of heating and cooling a cup which is held therein.

However, this technology has a problem in that the cooling and heating function due to thermal conduction does not properly work when the cup adjoins the cup holder at a small area. Specifically, the size of the cup is not always identical with the size of the cup holder. Some cups have a concave undersurface. In case of a paper cup which is made of a low-thermal conductivity material, heat transfer due to conduction rarely occurs, and thus the temperature of the cup tends to be the same as the ambient temperature.

Therefore, there is a demand for a cup holder which can properly realize a practical cooling and heating function by solving the foregoing problems.

In addition, U.S. Pat. No. 5,720,171 A1, titled “DEVICE FOR HEATING AND COOLING A BEVERAGE,” also discloses a cup holder. However, since this approach also realizes the cooling and heating of the cup holder only via conduction, there is the same problem in that actual cooling and heating efficiency is low.

The information disclosed in this Background section is only for the enhancement of understanding of the background of the present inventive concept, and should not be taken as an acknowledgment or any form of suggestion that this information forms a prior art that would already be known to a person skilled in the art.

### RELATED ART DOCUMENT

### Patent Document

U.S. Pat. No. 5,720,171 A1

### SUMMARY

Accordingly, the present inventive concept has been made keeping in mind the above problems occurring in the related art, and the present inventive concept is intended to propose a cooling and heating cup holder which can realize a practical cooling and heating function by employing an air conditioning mechanism that exceeds thermal conduction.

One aspect of the present inventive concept relates to a cooling and heating cup holder that includes an inner holder for holding a cup therein, the inner holder being made of metal and having a protrusion on a side portion thereof, a portion of the protrusion being open to define a flow hole; an outer holder surrounding the side surface of the inner holder at a predetermined interval from the inner holder, such that a circulation space is formed between the outer holder and inner holder. The thermoelectric device disposed in the circulation space, the thermoelectric device comprises an air conditioning section and a heat dissipating section, the air conditioning section closely adjoining the protrusion of the inner holder, and the heat dissipating section extending through the outer holder and being exposed outward. A blower is disposed inside the circulation space adjacent to the flow hole. The blower enables air inside the inner holder and air inside the circulation space to circulate and transfer heat.

The flow hole may be defined by the portion of the protrusion that is open.

The blower may be disposed adjacent to the flow hole of the protrusion which is open. The blower takes in air from the circulation space and blows the air into the inner holder through the flow hole.

The outer holder may have a guide disposed on an upper end thereof. The guide surrounds the upper end of the inner holder at a predetermined interval therefrom. The circulation space communicates with an inner space of the inner holder so that convection occurs therebetween.

The blower may be disposed adjacent to the flow hole. The blower takes in the air from the circulation space and blowing the air into the inner holder through the flow hole, such that the air inside the inner holder is guided by the guide so that the air enters the circulation space and is taken into the blower.

The air conditioning section may closely adjoin an outer surface of the protrusion, and air conditioning fins may be disposed on an inner surface of the protrusion.

The cooling and heating cup holder may further include a barrier panel in the inner holder. The barrier panel covers the air conditioning fins of the protrusion, and is spaced apart from a portion of the inner holder that is opposite the flow hole, thereby guiding the air that flows through the flow hole to circulate around an inside of the inner holder

Heat dissipation fins may be disposed on the heat dissipating section of the thermoelectric device which is exposed.

Another aspect of the present inventive concept encompasses a cooling and heating cup holder that includes an inner holder for holding a cup therein, the inner holder being made of metal and having a protrusion on a side portion thereof. A portion of the protrusion is open to form a flow hole. An outer holder surrounds the side surface of the inner holder at a predetermined interval from the inner holder, thereby forming a circulation space therebetween. A thermoelectric device is disposed in the circulation space. The thermoelectric device comprises an air conditioning section and a heat dissipating section. The air conditioning section closely adjoins the protrusion of the inner holder, and the heat dissipating section extends through the outer holder and being exposed outward. A blower is disposed inside the circulation space on an undersurface of the inner holder. The blower enables air inside the inner holder and air inside the circulation space to circulate and transfer heat.

The flow hole may be formed in the lower end of the protrusion in the direction toward the blower.

The blower may take in the air from the inner holder through the flow hole and then discharge the air into the circulation space.

According to embodiments of the present inventive concept, the cooling and heating cup holder can realize the practical cooling and heating function using both thermal conduction and thermal convection.

In addition, there is the advantage of high thermal efficiency, since the air which flows around the cup is continuously circulated.

### BRIEF DESCRIPTION OF THE DRAWINGS

The foregoing and other features of the inventive concept will be apparent from a more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept.

FIG. 1 is a view showing a cooling and heating cup holder of the related art.

FIG. 2 is an exploded perspective view showing a cooling and heating cup holder according to an embodiment of the present inventive concept.

FIG. 3 is a perspective view of the cooling and heating cup holder shown in FIG. 2.

FIG. 4 and FIG. 5 are cross-sectional views of the cooling and heating cup holder shown in FIG. 3.

FIG. 6 is a cross-sectional view showing a cooling and heating cup holder according to another embodiment of the present inventive concept.

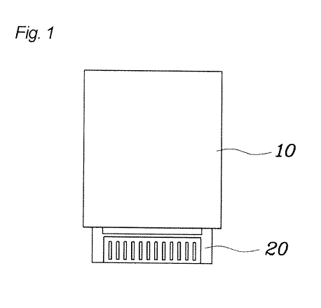

### DETAILED DESCRIPTION

Examples of the present inventive concept will be described below in more detail with reference to the accompanying drawings. The examples of the present inventive concept may, however, be embodied in different forms and should not be construed as limited to the examples set forth herein. Like reference numerals may refer to like elements throughout the specification.

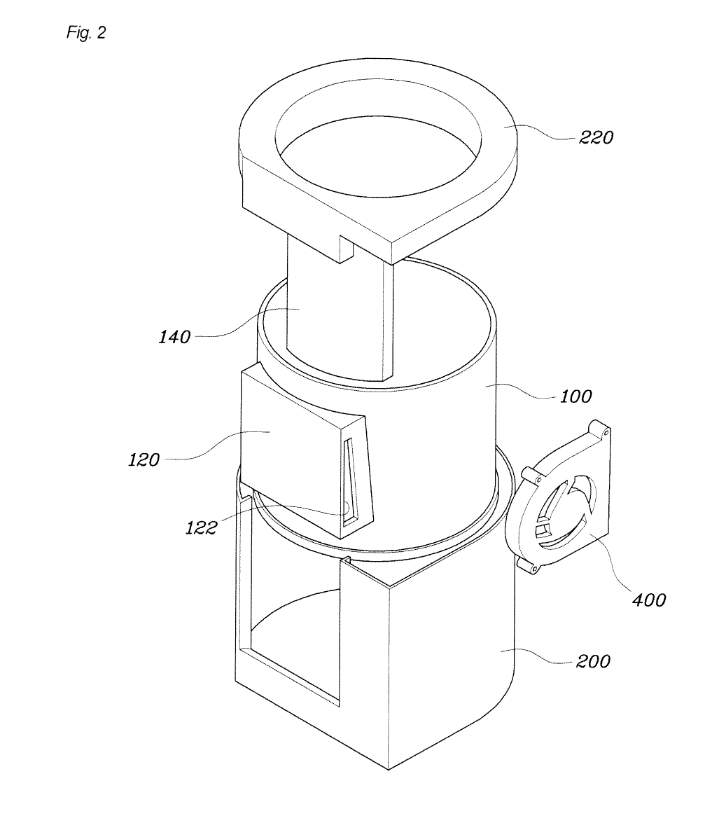

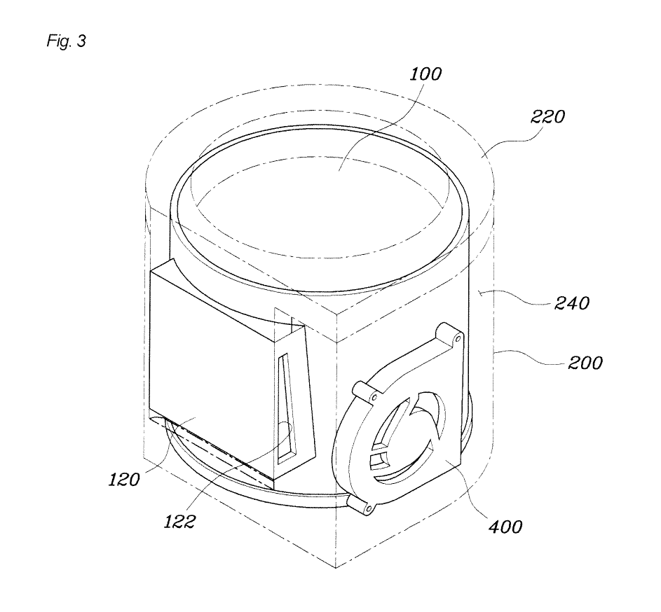

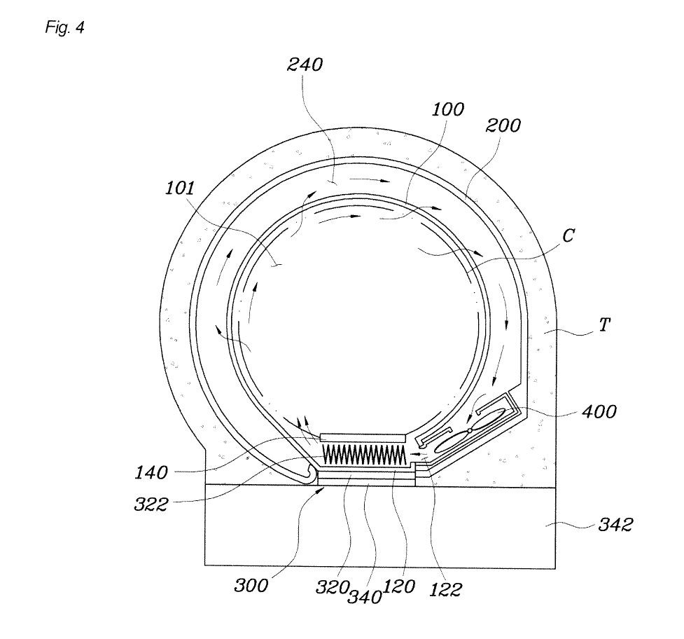

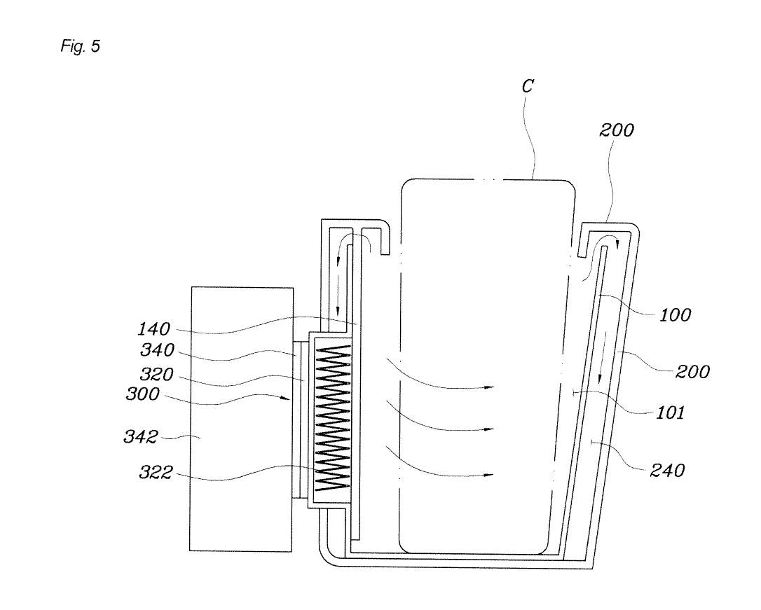

FIG. 2 is an exploded perspective view showing a cooling and heating cup holder according to an embodiment of the present inventive concept. FIG. 3 is a perspective view of the cooling and heating cup holder shown in FIG. 2. FIG. 4 and FIG. 5 are cross-sectional views of the cooling and heating cup holder shown in FIG. 3.

The cooling and heating cup holder according to an embodiment of the present inventive concept may include an inner holder 100 for holding a cup therein. The inner holder 100 may be made of metal, and have a protrusion 120 on a side portion thereof. A portion of the protrusion 120 may be open to form a flow hole 122.

An outer holder 200 may surround a side surface of the inner holder 100 at a predetermined interval from the inner holder 100, thereby forming a circulation space 240 therebetween (see FIG. 3). A thermoelectric device 300 (see FIG. 4) may be disposed in the circulation space 240. The thermoelectric device 300 may include an air conditioning section 320 and a heat dissipating section 340. The air conditioning section 320 may closely adjoin the protrusion 120 of the inner holder 100, and the heat dissipating section 340 may extend through the outer holder 200 and being exposed outward. A blower 400 (see FIG. 2) may be disposed inside the circulation space 240 adjacent to the flow hole 122, such that the blower 400 enables air inside the inner holder 100 and air inside the circulation space 240 to circulate and transfer heat.

Referring to FIG. 4, the cooling and heating cup holder according to an embodiment of the present inventive concept may include the inner holder 100 which holds a cup C therein and the outer holder 200 which surrounds the side surface of the inner holder 100. The inner holder 100 holding the cup C therein may be made of metal, and performs cooling or heating basically based on thermal conduction. The protrusion 120 may be formed on a side portion of the inner holder, preferably in the shape of a rectangular box. One portion of the protrusion 120 may be open, thereby forming the flow hole 122. The flow hole 122 allows air circulation between the inside and the outside of the inner holder, so that outer air which is air-conditioned and inner air inside an inner space of the inner holder which surrounds the cup can circulate toward each other. The flow hole 122 may open one side portion of the protrusion 120 such that air circulates through the side, thereby helping the air inside the inner holder 100 circulate basically in a shape that surrounds the cup C. The outer holder 200 may be configured such that the outer holder 200 surrounds the side surface of the inner holder 100 at an interval from the inner holder 100, thereby forming the circulation space 240 between the outer holder 200 and the inner holder 100.

The outer holder 200 may surround the side surface of the inner holder 100 at a predetermined interval therefrom, such that the circulation space 240 is formed between the inner and outer holders 100 and 200.

In addition, the thermoelectric device 300 may be disposed in the circulation space 240 between the inner holder 100 and the outer holder 200. The thermoelectric device 300 may use the Peltier effect as an embodiment of the present inventive concept. The thermoelectric device 300 may be composed of two sections, including the air conditioning section 320 and the heat dissipating section 340. When the air conditioning section 320 performs cooling, the heat dissipating section 340 may dissipate heat. The air conditioning section 320 and the heat dissipating section 340 can function to alternate cooling and heating in response to switching of electrodes.

The air conditioning section 320 of the thermoelectric device 300 may closely adjoin the protrusion 120 of the inner holder 100, and may cool or heat the inner holder made of metal through the protrusion 120. The heat dissipating section 340 may extend through the outer holder 200 and may be exposed outward, such that heat dissipation can be carried out from the outside using a separate blower. Heat dissipation fins 342 may be provided on an exposed portion of the heat dissipating section 340 of the thermoelectric device 300.

The air conditioning section 320 of the thermoelectric device 300 may closely adjoin an outer surface of the protrusion 120, and air conditioning fins 322 may be provided on an inner surface of the protrusion 120. This configuration enables heat exchange in such a fashion that air that enters and exits through the flow hole 122 can be efficiently cooled or heated as required.

Specifically, the air inside the inner holder 100 may be cooled and heated via convection, the inner holder 100 itself is cooled and heated, and furthermore, the air inside the inner holder 100 can be further cooled and heated in response to cooling and heating of the inner holder 100. Therefore, according to this structure, heat transfer can be carried out not only by heat conduction of the cup C but also by convection due to constant conditioning of the air that surrounds the cup C.

The blower 400 may be disposed inside the circulation space 240, at a position adjacent to the flow hole 122. The blower causes the air inside the inner holder 100 and the air in the circulation space 240 to circulate and convey heat through the flow hole 122. A fundamental force that enables convection originates from the blower 400. The blower 400 continuously circulates the air inside the circulation space 240 and the inner space 101 of the inner holder 100, and the protrusion 120 to which the thermoelectric device 300 is coupled is positioned on a path along which the air circulates. With this configuration, air conditioning is carried out by efficient convention.

In addition, the blower 400 may be disposed adjacent to the open flow hole 122 of the protrusion 120, and take the air from the circulation space 240 and blow the air into the inner holder 100 through the flow hole 122. A guide 220 (see FIGS. 2 and 3) may be provided on an upper end of the outer holder 200, and surround the upper end of the inner holder 100 at a predetermined interval therefrom. With this configuration, the circulation space 240 may communicate with the inner space 101 of the inner holder 100 such that the air circulates therebetween.

The blower 400 may be provided adjacent to the flow hole 122, and take the air from the circulation space 240 and discharge the air into the inner holder 100 through the flow hole 122. Thus, the air inside the inner holder 100 may be guided by the guide 220, be introduced into the circulation space 240, and be taken into the blower 400.

In addition, the inner holder 100 may have a barrier panel 140 which covers the air conditioning fins 322 in the protrusion 120. A portion of the barrier panel 140 that is opposite the flow hole 122 may be spaced apart from the inner holder 100. Thus, the barrier panel 140 may allow the air that flows through the flow hole 122 to circulate along the inside of the inner holder 100.

According to a series of the above-described configurations, the air inside the inner space 101 of the inner holder 100 which surrounds the cup C is taken into the circulation space 240 through the guide 220 at the upper portion while circulating around the cup C in response to the blower 400 taking in the air. The air that has been taken in is introduced into the blower 400, is air-conditioned by the protrusion 120 along the flow hole 122, and then is introduced again into the inner space 101 of the inner holder 100. Consequently, the conditioned air constantly flows around the cup C, and the air conditioning can be more effectuated as the air comes into contact with the inner holder 100 which is made of metal. Therefore, the cooling and heating is realized not only by heat conduction by the inner holder 100 but also by heat convection, so that the cooling can be carried out rapidly and the cooled state can be maintained for a long time.

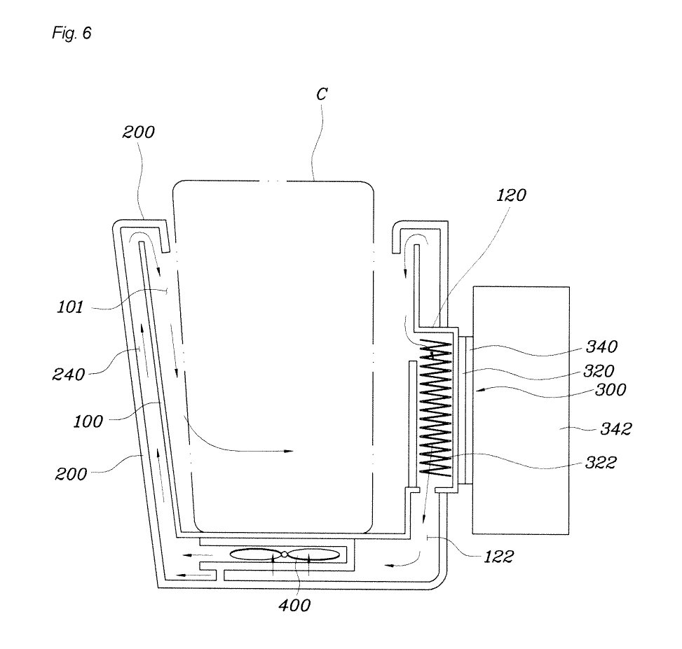

FIG. 6 is a cross-sectional view showing a cooling and heating cup holder according to another embodiment of the present inventive concept. The cooling and heating cup holder according to an embodiment of the present inventive concept may include an inner holder 100 for holding a cup therein. The inner holder 100 may be made of metal, and have a protrusion 120 (see FIG. 2) on a side portion thereof. A portion of the protrusion 120 may be open to form a flow hole 122. An outer holder 200 may surround the side surface of the inner holder 100 at a predetermined interval from the inner holder 100, thereby forming a circulation space 240 therebetween. A thermoelectric device 300 may be disposed in the circulation space 240. The thermoelectric device 300 may include an air conditioning section 320 and a heat dissipating section 340. The air conditioning section 320 may closely adjoin the protrusion 120 of the inner holder 100. The heat dissipating section 340 may extend through the outer holder 200 and be exposed outward. A blower 400 may be disposed inside the circulation space 240 on an undersurface of the inner holder 100, such that the blower 400 enables air inside the inner holder and air inside the circulation space to circulate and transfer heat.

In addition, the flow hole 122 can be formed in a lower end of the protrusion 120 so as to face the blower 400. The blower 400 may take in the air inside the inner holder 100 through the flow hole 122, and then discharge the air into the circulation space 240.

In this case, the blower 400 may be located at a lower position. This configuration can advantageously reduce the thickness of a sidewall of the cup holder. Since the blower 400 may be located at the lower position, the flower hole 122 is formed to face downward. The flow of the air may be reversed as follows: air that is conditioned by the thermoelectric device 300 first enters the circulation space 240, exits the circulation space 240, and then enters the inner holder 100. This is because air naturally flows downward under gravity, whereas the operation of blowing the air upward through the flow hole 122 causes friction because the air upward through the flow hole 122 is against gravity.

According to the cooling and heating cup holder having the above-described structure, the practical cooling and heating function is realized using both heat conduction and heat convection.

In addition, there is an advantage of high heat efficiency since the air which flows around the cup is continuously circulated.

Although the exemplary embodiments of the present inventive concept have been described for illustrative purposes, those skilled in the art will appreciate that various modifications, additions and substitutions are possible, without departing from the scope and spirit of the present inventive concept as disclosed in the accompanying claims.

What is claimed is:

1. A cooling and heating cup holder, comprising:
an inner holder for holding a cup therein, the inner holder being made of metal and having a protrusion on a side portion thereof, a portion of the protrusion being open to define a flow hole;
an outer holder surrounding a side surface of the inner holder at a predetermined interval from the inner holder, such that a circulation space is formed between the outer holder and the inner holder;
a thermoelectric device disposed in the circulation space, the thermoelectric device comprising an air conditioning section and a heat dissipating section, the air conditioning section closely adjoining the protrusion of the inner holder, and the heat Is dissipating section extending through the outer holder and being exposed outward; and
a blower disposed inside the circulation space adjacent to the flow hole, such that the blower enables air inside the inner holder and air inside the circulation space to circulate and transfer heat.

2. The cooling and heating cup holder of claim 1, wherein the flow hole is defined by a portion of the protrusion that is open.

3. The cooling and heating cup holder of claim 2, wherein the blower is disposed adjacent to the flow hole of the protrusion which is open, such that the blower takes in air from the circulation space and blows the air into the inner holder through the flow hole.

4. The cooling and heating cup holder of claim 1, wherein the outer holder has a guide disposed on an upper end thereof, the guide surrounding an upper end of the inner holder at a predetermined interval therefrom, such that the circulation space communicates with an inner space of the inner holder so that convection occurs between the circulation space and the inner space of the inner holder.

5. The cooling and heating cup holder of claim 4, wherein the blower is disposed adjacent to the flow hole, such that the blower takes in the air from the circulation space and blows the air into the inner holder through the flow hole, such that the air inside the inner holder is guided by the guide so that the air enters the circulation space and is taken into the blower.

6. The cooling and heating cup holder of claim 1, wherein:
the air conditioning section closely adjoins an outer surface of the protrusion, and
air conditioning fins are disposed on an inner surface of the protrusion.

7. The cooling and heating cup holder of claim 6, further comprising:
a barrier panel in the inner holder, the barrier panel covering the air conditioning fins of the protrusion, and being spaced apart from a portion of the inner holder that is opposite the flow hole, such that the air that flows through the flow hole is guided to circulate around an inside of the inner holder.

8. The cooling and heating cup holder of claim 1, wherein heat dissipation fins are disposed on the heat dissipating section of the thermoelectric device which is exposed.

9. A cooling and heating cup holder, comprising:
an inner holder for holding a cup therein, the inner holder being made of metal and having a protrusion on a side portion thereof, a portion of the protrusion being open to define a flow hole;
an outer holder surrounding a side surface of the inner holder at a predetermined interval from the inner holder, such that a circulation space is formed between the outer holder and the inner holder;
a thermoelectric device disposed in the circulation space, the thermoelectric device comprising an air conditioning section and a heat dissipating section, the air conditioning section closely adjoining the protrusion of the inner holder, and the heat dissipating section extending through the outer holder and being exposed outward; and
a blower disposed inside the circulation space on an undersurface of the inner holder, such that the blower enables air inside the inner holder and air inside the circulation space to circulate and transfer heat.

10. The cooling and heating cup holder of claim 9, wherein the flow hole is defined in a lower end of the protrusion in a direction toward the blower.

11. The cooling and heating cup holder of claim 9, wherein the blower is configured to take in the air from the inner holder through the flow hole and then discharge the air into the circulation space.
